(19) United States
(12) Patent Application Publication
(10) Pub. No.: US 2017/0011440 A1
(43) Pub. Date: Jan. 12, 2017

(54) ONLINE MOBILE PAYMENT USING A SERVER

(71) Applicants: Jack Shauh, San Diego, CA (US); Kuo-Chun Lee, San Diego, CA (US)

(72) Inventors: Jack Shauh, San Diego, CA (US); Kuo-Chun Lee, San Diego, CA (US)

(21) Appl. No.: 15/203,779

(22) Filed: Jul. 6, 2016

Related U.S. Application Data
(60) Provisional application No. 62/189,304, filed on Jul. 7, 2015.

(51) Int. Cl. G06Q 30/06; H04W 8/26; H04L 29/12; G06Q 20/32

(52) U.S. Cl. CPC G06Q 30/0613; G06Q 20/322; H04W 8/26; H04L 61/2007

(57) ABSTRACT

A mobile payment system includes a web browsing capable device in communication with the Internet to make online purchases at online merchants, a mobile payment device having securely stored payment information, and a server to identify the mobile device and receive the payment information for the online purchase by the web browsing capable device.

### CROSS-REFERENCE TO RELATED APPLICATION

This application claims the benefit of U.S. Provisional Application No. 62/189,304, filed 7 Jul. 2015.

### FIELD OF THE INVENTION

This invention relates to mobile payment systems.

More particularly, the present invention relates to mobile payment for online purchases.

### BACKGROUND OF THE INVENTION

In the payments industry, mobile payments systems are becoming more widely used. Mobile payment applications as a virtual credit/debit card are starting to be provided to mobile devices such as smart phones, tablets, watches and other wearable devices, and the like. Mobile payment methods currently include Apple Pay, Android Pay, etc. As an example, a mobile device capable of mobile payment, can be used in a point of sale (POS) terminal to pay for a sale in a retailer store. Mobile payment can provide strong security to prevent fraud by implementing EMV (Europay, MasterCard and Visa) Integrated Circuit Card Specifications for Payment Systems. Furthermore, mobile payment can provide strong security by implementing EMV Payment Tokenization Specifications, or vendor specific payment token scheme.

However, the existing mobile payment cannot be used in online purchasing when the user is purchasing through a PC or other web browsing capable device and the mobile payment resides on a different mobile device. In this case, the user has to manually enter credit or debit card number on the web page of the online store, which can create security fraud because there is no strong authentication in the purchase process.

It would be highly advantageous, therefore, to remedy the foregoing and other deficiencies inherent in the prior art.

An object of the present invention is to provide a method and system of mobile payment for us with a PC.

Another object of the present invention is to provide a Secure method and system of mobile payment for us with a PC.

### SUMMARY OF THE INVENTION

Briefly, to achieve the desired objects and advantages of the instant invention, provided is a mobile payment system including a web browsing capable device in communication with a world wide web to make purchases online at an online store, a server connected to the online merchant, and a mobile payment device having securely stored payment information connectable to the server to provide payment for the online purchase. A unique identifier is associated with the mobile device and stored by the server to permit connection to the associated mobile device. The online store is connectable to a payment network to exchange payment messages upon receiving payment information from the server.

Also provided is a mobile payment method including the steps of providing a web browsing capable device, providing a mobile payment device having mobile payment capability, and providing a server connectable to an online merchant and the mobile device. The web browsing capable device communicates with the Internet to make an online purchase at the online merchant. The server is provided with a unique identifier associated with the mobile device. A transaction authorization request is sent from the online merchant to the server. The unique identifier is associated with the mobile device by the server to identify the mobile device making a mobile payment. A payment request is sent from the server to the mobile device using the unique identifier to identify the mobile device. A payment response is sent from the mobile device to the server. A transaction authorization response is sent from the server to the online merchant, and an authorization request is sent from the online merchant to a payment network.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is simplified block diagram of the payment system according to the present invention;

FIG. 2 is a schematic of the message exchange between elements of the payment system with a registered user, according to the present invention;

FIG. 3 is a schematic of the message exchange between elements of the payment system with an unregistered user, according to the present invention; and

FIG. 4 is a schematic of the message exchange between elements of the payment system illustrating account setup and registration with the server.

### DETAILED DESCRIPTION OF THE PREFERRED EMBODIMENTS

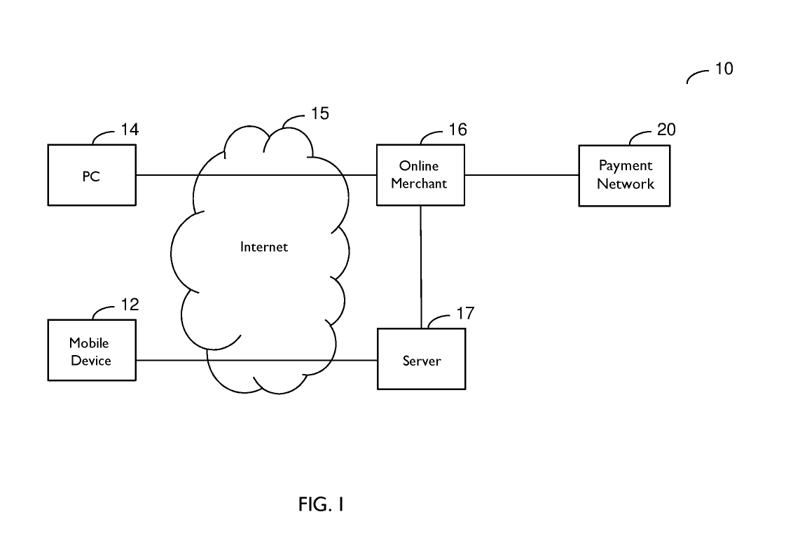

Turning now to the drawings in which like reference characters indicate corresponding elements throughout the several views, attention is first directed to FIG. 1 which illustrates a payment system 10 including a mobile payment device 12 and a PC 14 (web browsing capable device). Mobile payment device 12 is a device with computing capability and is embedded with a secure element or utilizes emulation software to emulate a secure element to securely store credit/debit card information, payment credentials, one-time credit/debit card number, payment token, etc. Mobile payment device 12 can be a smart phone, a tablet, a wearable device (e.g. watch), or even a laptop PC, embedded with a secure element or utilizing emulation software to emulate a secure element, that stores credit/debit card, payment credentials, one-time credit/debit card number, payment token, etc. Currently mobile payment platforms include Apple Pay, Android Pay and the like. PC 14 can be any browser capable device such as a desktop PC, a laptop PC, a tablet PC, mobile phone (or smart phone), etc. to browse products of the online store. In this case, PC 14 is either incapable of mobile payment, or mobile payment is undesirable from that specific device. System 10 enables a secondary device, in this case mobile payment device 12 to pay for online purchases at online merchant 16 made from PC 14. It will be understood that the term online refers to communication through a world wide web such a the Internet 15, a global communications network. Many users prefer to browse on a larger device such as a desk top computer because a larger viewing area is provided. Unfortunately, mobile payment is not available on many of these systems. System 10 allows browsing on a PC 14 while facilitating payment with a mobile payment device 12.

To allow online merchant 16 to contact mobile device 12 to pay, a server 17 is provided that can accept registration from mobile device 12 so that server 17 can obtain the IP address of mobile device 12 to forward a notification of payment. To provide security, a unique ID may be used at online merchant 16 to identify mobile device 12. Server 17 stores the unique ID associated with the mobile phone number of the mobile device 12. Also, the use of an ID may solve the issue that some mobile devices, such as tablet PC, watch, wearable, do not have mobile phone numbers.

As an example of general use, PC 14 connects to Online Merchant 16 via Internet connection 15. Online Merchant 16 connects to a Payment Network 20 to process the credit, debit or bank card transaction approval. Mobile Device 12 is capable of mobile payment and is reachable by Server 17 using Internet link 15 to exchange mobile payment messages. Mobile Device 12 can use 2G, 3G, or 4G cellular networks, or home, private or public Wi-Fi as the access technology of Internet 15. Server 17 connects between Online Merchant 16 and Mobile Device 12.

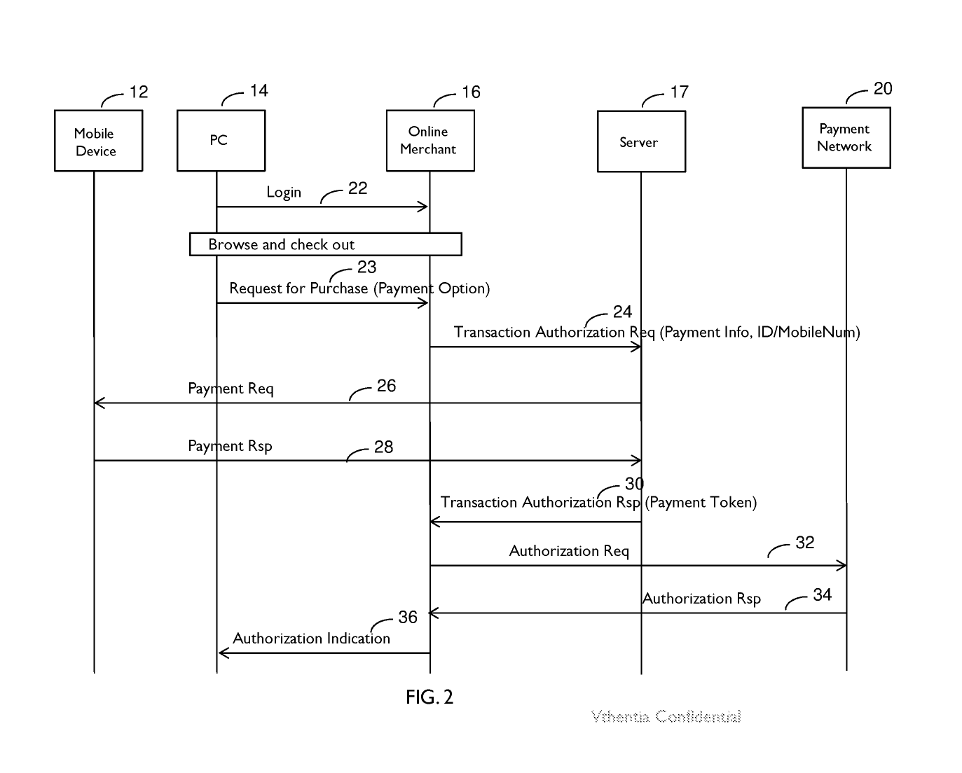

Referring now to FIG. 2, an example of the message flow for a mobile payment using system 10 is illustrated. To provide the required functionality, both mobile payment device 12 and PC 14 may need to install 3rd party software to enable these messages and procedures. Online store 16 also needs some software upgrade, such as in the web page to provide a software script, to receive from 3rd party software of PC 14 some data or messages as well as transmit some data or messages to 3rd party software of PC 14.

The user intends to purchase on the web page of Online Merchant 16 and performs a login step 22. Login 22 is accomplished by providing a user name and a password. The user uses PC 14 to browse products of Online Merchant 16 and add selected products to the shopping cart well known on in the art. The user then proceeds to check out and requests purchase 23. Online Merchant 16 displays all payment options, e.g. mobile payment with a second device, etc. Then the user selects the mobile payment with a second device option for this transaction. Since the user has previously registered with this Online Merchant 16 with one Mobile Device 12 capable of mobile payment associated with the user name, Online Merchant 16 may display the mobile phone number to get confirmation from the user. If the user has registered multiple Mobile Devices 12 previously associated with the user name, then Online Merchant 16 displays all mobile phone numbers and request user to choose one. Alternatively, to prevent theft of the mobile phone number for payment, the user may register Online Merchant 16 with a unique ID during the account set up process with Server 17 and an icon, such as iPhone 6. The explicit mobile phone number(s) or implicit ID(s) may continue to be stored in the database of Online Merchant 16 for future use. Online Merchant 16 sends Transaction Authorization Request 24 to Server 17 with Payment Information and ID or the mobile phone number of Mobile Device 12 used for payment.

When Server 17 receives Transaction Authorization Request 24 from Online Merchant 16, Server 17 checks its database to determine if Mobile Device 12 is registered and to obtain the current IP address of Mobile Device 12, if registered, by matching the ID or mobile phone number to mobile device 12. Server 17 then sends a Payment Request message 26 to the IP address of Mobile Device 12. Before sending the message, Server 17 and Mobile Device 12 may set up a secured link, e.g. using HTTPS.

Alternatively, Server 17 may maintain a long lived TCP or HTTP(S) connection with the Mobile Device 12. When Server 17 receives Transaction Authorization Request 24 from Online Merchant 16, Server 17 checks if such a long lived connection with this Mobile Device 12 exists by matching the ID or mobile phone number of mobile device 12 with the connection Id. Server 17 then sends a Payment Request message 26 to the TCP connection or HTTP(S) connection with Mobile Device 12.

Furthermore, Server 17 and Mobile Device 12 may have access to the existing notification service, such as Apple Push Notification Service, Google Cloud Messaging, etc. When Server 17 receives Transaction Authorization Request 24 from Online Merchant 16, Server 17 may send a Payment Request message 26 to the Mobile Device 12 using the existing notification service. To send a notification message to Mobile Device 12, the Server 17 stores the client ID of the notification service associated with the ID or mobile phone number to Mobile Device 12.

Mobile Device 12 receives Payment Request notification 26 and provides a signal to the user by sound and/or vibration of Mobile Device 12. Mobile Device 12 displays title of payment, amount to pay, merchant name and other relevant information which comes from payment information sent by Online Merchant 16 in Transaction Authorization Request 24. The user approves payment, which can involve some biometric verification of the user with fingerprint, etc. Mobile Device 12 replies with a Payment Response message 28 to server 17, where Payment Response message 28 indicates some cryptogram for authenticating the card. Some mobile payment does not include the actual card number, instead, a payment token is included. Server 17 sends a Transaction Authorization Response 30 to Online Merchant 16. Transaction authorization response includes, for example, a payment token. Online Merchant 16 then sends an Authorization Request message 32 to Payment Network 20 to process the transaction. Upon receiving Authorization Request 30, Payment Network can provide security processing, such as decryption, card authentication, etc. If the card information is based on virtual card information, such as payment token, Payment Network 20 may provide de-tokenization to get the actual card number. Payment network 20 replies with an Authorization Response 34 to Online Merchant 16. Online Merchant 16 sends an Authorization Indication 36 to PC 14 indicating the status of authorization.

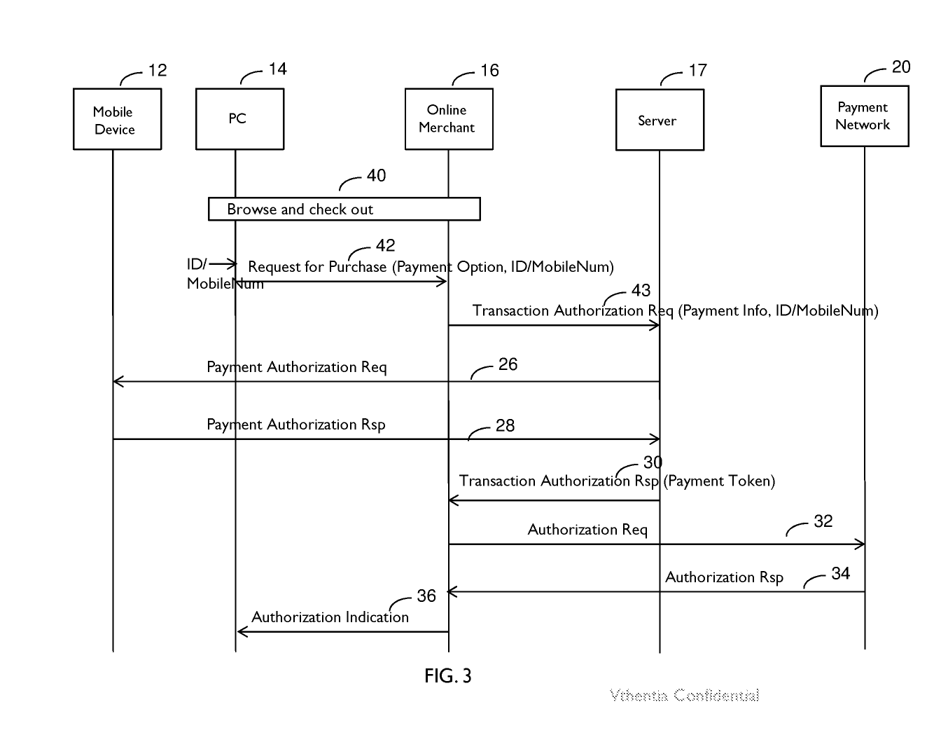

Turning now to FIG. 3, another example of a message flow is illustrated. In this example, the user provides an implicit ID or explicit mobile phone number of the corresponding Mobile Device 12 to Online Merchant 16 when the user decides to check out. Therefore, Server 17 can receive the ID and determine the mobile phone number of Mobile Device 12 to notify of the mobile payment. The user uses PC 14 to browse products of Online Merchant 16, add selected products to the shopping cart and proceed to check out 40. Online Merchant 16 displays all payment options, such as mobile payment to a mobile device 12. The user then selects the mobile payment with a second device (mobile device 12) option for this transaction. Since the user does not previously register with this Online Merchant with any mobile device 12 capable of mobile payment or does not leave mobile device's ID or mobile phone number, Online Merchant 16 then requires the user to input a request for purchase 42 including an ID or mobile phone number of Mobile Device 12. Alternatively, the Internet browser may cache and auto fill ID or mobile phone number if user previously provided this information in the form. Online Merchant 16 sends a Transaction Authorization Request 43 to Server 17 with Payment Information and ID or mobile phone number of the Mobile Device 12 being used for payment. The remaining steps are the same as described previously with respect to FIG. 2.

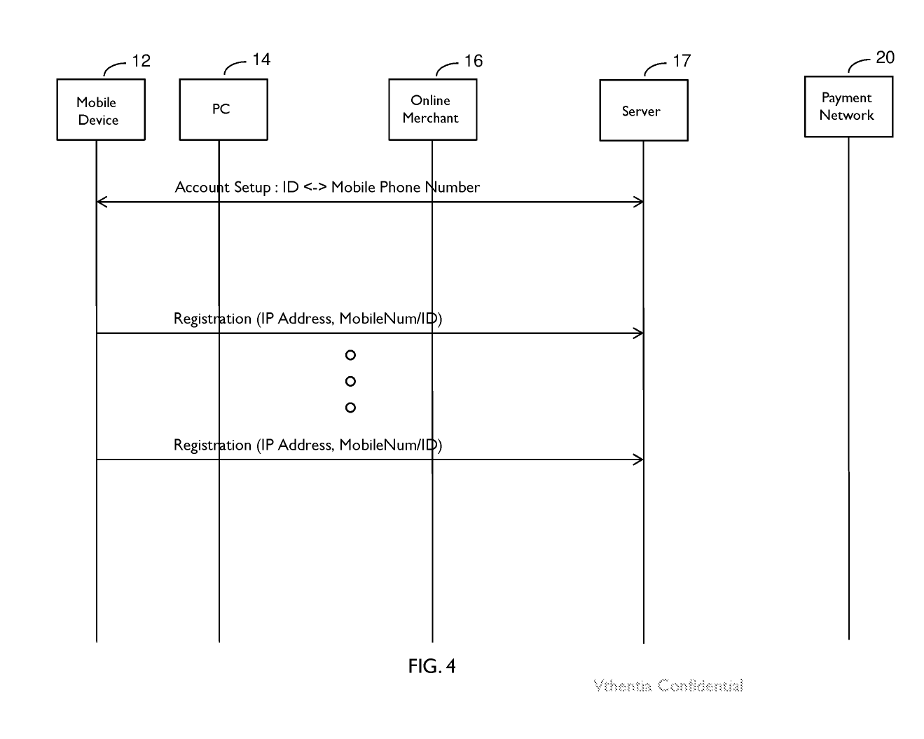

Prior to use of payment system 10, a user who desires to use mobile payment with a second device (mobile device 12), the user may need to first download an application to Mobile Device 12. Mobile device 12 is then used to set up an account with Server 17. Once registered, Mobile Device 12 periodically connect with Server 17 using the IP address of Mobile Device 12 and associated ID or mobile phone number. Turning now to FIG. 4, illustrated is an example of a message exchange of account setup and registration with Server 17. The user uses Mobile Device 12 to set up an account. As a result, a unique ID may be allocated by Server 17 or chosen by the user. If the mobile phone number is available, the associated ID and mobile phone number of Mobile Device 12 is stored in Server 17. Mobile Device 12 periodically registers or re-registers with Server 17 using the IP address of Mobile Device 12 and the associated ID or mobile phone number. For example, SIP registration may be used for this purpose. In the case when Mobile Device 12 detects a change of its IP address, Mobile Device 12 immediately registers with Server 17 using the new IP address of Mobile Device 12 and associated ID or mobile phone number.

Alternatively, to maintain a long lived TCP or HTTP(S) connection, the Mobile Device 12 periodically refreshes connection by sending some data. The Mobile Device 12 may perform similar periodical refresh procedure when the existing notification service is used.

Secured communication may be needed in any of the above communication with Server 17, including between Mobile Device 12 and Server 17, and between Server 17 and Online Merchant 16. Security credential may be provisioned. For example, Mobile Device 12 and Server 17 may be provisioned with a shared security key. It will be understood that Server 17 may be part of Online Merchant 16, or a third party server. Also, Server 17 can provide the interface with Payment Network 20 to process credit, debit or bank card transaction approval, i.e. Steps 32 and 34 of the methods illustrated in FIG. 2 and FIG. 3. In this case, Online Merchant 16 will receive the Authorization Response Indication from Server 17 and Step 30 in FIG. 2 and FIG. 3 is not needed.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A mobile payment system comprising:
a web browsing capable device in communication with a world wide web to make purchases online at an online store;
a server connected to the online merchant;
a mobile payment device having securely stored payment information connectable to the server to provide payment for the online purchase;
a unique identifier associated with the mobile device stored by the server to permit connection to the associated mobile device; and
wherein the online store is connectable to a payment network to exchange payment messages upon receiving payment information from the server.

2. A system as claimed in claim 1 wherein the unique identifier is an ID assigned to the mobile device.

3. A system as claimed in claim 1 wherein the mobile payment device includes an IP address, a connection Id, or a client Id of notification service associated with the unique identifier.

4. A system as claimed in claim 1 wherein the mobile payment device is connectable to the server through an internet link.

5. A system as claimed in claim 1 wherein the mobile payment device is registered to the server with a unique identifier prior to the purchase.

6. A system as claimed in claim 1 wherein the web browsing capable mobile payment device supplies a unique identifier to the online merchant and the online merchant supplies the unique identifier associated with the mobile device to the server during the payment process.

7. A system as claimed in claim 1 wherein the online merchant stores a unique identifier for the user name, and retrieves the unique identifier for a user name from login, and the online merchant supplies the unique identifier associated with the mobile device to the server during the payment process.

8. A mobile payment method comprising the steps of:
providing a web browsing capable device;
providing a mobile payment device having mobile payment capability;
providing a server connectable to an online merchant and the mobile device;
using the web browsing capable device in communication with the Internet to make an online purchase at the online merchant;
connecting the mobile device to the server to make a mobile payment for the online purchase; and
sending payment information to a payment network.

9. A method as claimed in claim 8 wherein the step of connecting the mobile device to the server includes providing a unique identifier associated with the mobile device to the server.

10. A method as claimed in claim 9 wherein the step of providing the unique identifier includes registering the mobile device with the server.

11. A method as claimed in claim 10 wherein the step of registering the mobile device includes setting up an account, assigning a unique identifier to the mobile device, and storing the unique identifier on the server.

12. A method as claimed in claim 11 wherein the step of storing the unique identifier includes associating the unique identifier with the telephone number of the mobile device.

13. A method as claimed in claim 9 further comprising the steps of:
sending a transaction authorization request from the online merchant to the server;
sending a payment request from the server to the mobile device using the unique identifier to identify the mobile device;
sending a payment response from the mobile device to the server; and
sending a transaction authorization response from the server to the online merchant.

14. A mobile payment method comprising the steps of:
providing a web browsing capable device;
providing a mobile payment device having mobile payment capability;
providing a server connectable to an online merchant and the mobile device;
using the web browsing capable device in communication with the Internet to make an online purchase at the online merchant;
providing the server with a unique identifier associated with the mobile device;
sending a transaction authorization request from the online merchant to the server;
associating the unique identifier to the mobile device to identify the mobile device;
sending a payment request from the server to the mobile device using the unique identifier to identify the mobile device;
sending a payment response from the mobile device to the server;
sending a transaction authorization response from the server to the online merchant; and
sending an authorization request from the online merchant to a payment network.

15. The method of claim 14 wherein the step of providing the server with a unique identifier associated with the mobile device includes registering the mobile device with the server prior to the online purchase.

16. The method of claim 14 wherein the step of providing the server with a unique identifier associated with the mobile device includes sending a unique identifier associated with the mobile device to the online merchant with the online purchase from the web browsing capable device, and sending the unique identifier from the online merchant to the server with the transaction authorization request.

17. The method of claim 14 wherein the step of providing the server with a unique identifier associated with the mobile device includes storing a unique identifier associated with the user name, retrieving the unique identifier corresponding to a user name from login by the online merchant, and sending the unique identifier from the online merchant to the server with the transaction authorization request.

18. The method of claim 14 wherein the step of sending an authorization request to a payment network includes the server providing the interface with the Payment Network.
